(19) United States
(12) Patent Application Publication
(10) Pub. No.: US 2026/0246806 A1
(43) Pub. Date: Aug. 20, 2026

(54) MITIGATING SECURITY VULNERABILITIES USING LANGUAGE MODELS

(71) Applicant: Cisco Technology, Inc., San Jose, CA (US)

(72) Inventors: Prashanth Arun, San Jose, CA (US); Ehsan Aghaei, Charlotte, NC (US); Anand Raghavan, Santa Clara, CA (US)

(21) Appl. No.: 19/081,996

(22) Filed: Mar. 17, 2025

Related U.S. Application Data
(60) Provisional application No. 63/761,115, filed on Feb. 20, 2025.

(51) Int. Cl. H04L 9/40; H04L 41/16

(52) U.S. Cl. CPC H04L 63/1433; H04L 41/16

(57) ABSTRACT

Techniques for utilizing a language model to mitigate a network vulnerability are described. A language model is deployed that is configured to respond to inputs from network operators. The language model receives a first input from the network operator indicating a description of a network vulnerability. The language model receives a second input including information associated with a configuration of the network. The language model determines a series of actions to execute to mitigate the network vulnerability. Finally, the language model outputs the series of actions to execute to the network operator.

### RELATED APPLICATIONS

This application claims priority to U.S. Provisional Patent Application No. 63/761,115 filed on Feb. 20, 2025, the entire contents of which are incorporated herein by reference and for all purposes.

### TECHNICAL FIELD

The present disclosure relates generally to provisioning language models to mitigate network vulnerabilities.

### BACKGROUND

Computer networks, or groups of connected computers or other devices that use communication protocols to exchange data, have continued to become more complex. As network complexity continues to increase, managing and updating configurations for networking devices for security reasons in a production environment is complex due to the high volume of devices, varying configuration requirements, and the need for stringent security compliance. Enterprise organizations today are faced with an ever-growing landscape of cybersecurity vulnerabilities. When these vulnerabilities are known, they may be cataloged and standardized in the Common Vulnerabilities and Exposures (CVE) database. The CVE system provides a reference method for publicly known security vulnerabilities which can exist in software, hardware, or any other digital system. The CVE system enables enterprise organizations to track and communicate security issues effectively. A CVE entry in the CVE database includes a description of a specific vulnerability, including information on affected systems, impact, and sometimes potential remediations. These descriptions are typically high-level descriptions and often lack the contextual details required to determine effective compensating controls in a real-world environment. Translating these descriptions into actionable controls that align with an enterprise organization's existing security policies and architecture requires deep technical knowledge and domain-specific insight. Thus, the management of remediation strategies in response to CVEs requires meticulous and highly technical manual effort by networking personnel and demands constant vigilance and precision.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a language model is deployed in a network to mitigate network vulnerabilities.

FIG. 2 illustrates an example environment for utilizing multiple language models to output a series of optimal actions to mitigate network vulnerabilities.

FIG. 3 illustrates an example process flow for utilizing multiple language models to output a series of optimal actions to mitigate network vulnerabilities.

FIG. 4 illustrates a flow diagram of an example method using a language model to determine actions to execute to mitigate network vulnerabilities.

FIG. 5 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to provisioning language models in a detect and response system to automate the identification, containment, eradication, and recovery of a security incident. A language model uses function calling to determine that a potential security incident is a true positive, and determining how to respond to the security incident, document the security incident, contain the security incident, and finally eradicate the security incident.

A method described herein may include deploying a language model to a network that is configured to respond to inputs from network operators associated with the network. Additionally, the method may include receiving, by the language model, an input from a network operator indicating a description of a network vulnerability. The method may also include receiving, by the language model, a second input including information associated with a configuration of the network. Based at least in part on the description of the network vulnerability and the information associate with the configuration of the network, the method may also include determining, by the language model, a series of actions to execute to mitigate the network vulnerability. Finally, the method may include outputting, by the language model, the series of actions to execute to the network operator.

In some examples determining the series of actions to execute further comprises determining network devices that are affected by the network vulnerability and determining one or more actions to execute on each of the network devices to mitigate the network vulnerability. In various embodiments, the language model is a first language model that determines a high-level configuration change to the configuration of the network that will mitigate the network vulnerability, determines a natural language description of a series of subtasks for implementing the high-level configuration change, inputs the natural language description of each subtask into a second language model, and receives an action to execute from each subtask from the second language model. Each action to execute may include a network device on which to execute the action. In some instances, each subtask is input into the second language model multiple times and the second language model generates multiple possible actions to execute to implement the subtask. The second language model may also input a description of each of the multiple possible actions to execute into a decision tree model and receive an optimal action to execute for the subtask from the decision tree model. In some examples, the series of actions to execute include a series of Command Line Interface (CLI) commands for input to one or more network devices. In various embodiments, the network vulnerability is a Common Vulnerabilities and Exposures (CVE) report received from a CVE database. In some examples, the language model is a large langue model (LLM).

Additionally, the techniques of at least the first method and the second method and any other techniques described herein, may be performed by a system and/or device having non-transitory computer-readable media storing computer-executable instructions that, when executed by one or more processors, performs the method(s) described above.

### EXAMPLE EMBODIMENTS

As described above, the Common Vulnerabilities and Exposure (CVE) database provides a repository for publicly known security vulnerabilities which can exist in software or hardware in a network. The CVE system enables enterprise organizations to track and communicate security issues effectively. A CVE entry in the CVE database includes a description of a specific vulnerability, including information on affected systems, impact, and sometimes potential remediations. These descriptions are typically high-level descriptions and often lack the contextual details required to determine effective compensating controls in a real-world environment. Translating these descriptions into actionable controls that align with an enterprise organization's existing security policies and architecture requires deep technical knowledge and domain-specific insight. Thus, there is a need for a systematic and scalable process for translating CVE descriptions into effective, tailored compensating controls that are practical for the particular environments of different customers.

Various types of virtual agents have emerged over the years with the purposes of interacting with and providing assistance to users as though they are human assistants. One type of virtual agent, known as a chatbot, is a computer program that has conversations with users through text or speech. Traditionally, chatbots operated under rule-based systems where rules and decision trees were used to recognize specific words or phrases provided by users, and provide predefined responses to the users based on these words or phrases. However, these chatbots were fairly limited and had difficulties handling unexpected or complex queries from users. Thus, while rule-based chatbots could handle basic tasks, these chatbots had fairly limited usefulness and provided little value for users.

More recently, there have been advances in AI that have enabled chatbots and other AI systems to perform complex tasks that normally require human intelligence. Generative AI is a type of artificial intelligence where models are used to create (or “generate”) new content based on inputs, often in the form of inputs from users. One type of generative AI model is particularly effective at generating text, specifically, the language model (e.g., the large language model (LLM)). Language models are trained on large sets of corpuses of text data to perceive and infer context from user queries, understand a broader range of queries, and generate human-like textual responses to the queries. Chatbots that are backed by language models are becoming increasingly popular among users due to their ability to perform complex tasks on behalf of users.

This disclosure describes techniques for translating CVE descriptions into concrete actionable configuration steps, tailored for a customer's environment/deployment, that uses a language model's capability for complex reasoning to understand and recommend product configuration changes to handle CVE reports. These techniques develop a systematic and scalable process for translating the CVE descriptions into effective tailored compensating controls that are practical for customer environments that minimize the impact on the network of a customer until vulnerabilities can be patched. A determination can be made as to how a known network vulnerability affects the particular network of an enterprise organization, and based on the vulnerability and the particular network architecture, optimal mitigating actions can be initiated. In some instances, a known network vulnerability (e.g., CVE) may not affect an enterprise organizations particular network at all, thus, no mitigating actions needs taken. In other instances, a known vulnerability may be devastating to a particular network architecture. In this instance, the techniques described herein provide an automated process for determining an optimal mitigation strategy without requiring the meticulous and highly technical manual efforts by networking personnel that conventional mitigating strategies required.

Generative AI models are used for translating CVE descriptions into actionable controls that align with an organization's existing security policies and architecture. The actionable controls may consist of network hardening with firewall rules, web application firewalls, signature-based intrusion prevention, and the like. The techniques described herein provide for an automated process for taking a high-level description of a network vulnerability and breaking it down into smaller configuration change steps. Each smaller configuration change step is then analyzed to determine a specific action to take that will implement the relatively small configuration change, as well as specific network devices on which to perform the specific action. As more than one action may be taken to accomplish each relatively small configuration change, all possible actions may be evaluated to determine an optimal action to execute, and prune away less preferable actions to execute. This process can be automated with generative AI, and either automatically implemented, or output to a network operator to approve and/or carry out the actionable steps. Thus, conventional systems that require extensive and highly technical manual resources to translate a network vulnerability into actionable steps may be automated or partially automated by providing an AI-based assistant that can analyze a network vulnerability from a CVE report (or other source) and recommend specific actionable steps to mitigate the vulnerability. Language models may be utilized according to the techniques described herein to replace (or augment) and assist network administrators (also referred to as “network operators” herein) in determining and implementing actionable steps for a network configuration change necessary to mitigate known network vulnerabilities.

A network operator may login to a console and once authenticated, may input a text description of a network vulnerability, a CVE number, or provide the specific CVE that is of concern. The network operator may receive a series of actionable steps to execute to mitigate the input network vulnerability. For example, the network operator may receive instruction regarding specific devices in the enterprise network for which to execute a specific set of Command Line Interface (CLI) commands. In some examples, the network operator may be prompted for approval to execute one or more steps to accomplish the change. In other instances, the changes may automatically be executed depending on the extent of the change, and/or according to policies of an enterprise organizations.

On the backend, a language model (e.g., a large language model (LLM)) receives the network vulnerability (e.g., CVE number) input by the network operator. Additionally, the language model may receive information associated with the particular configuration of the network involved. This information may be received from network security management (e.g., cloud security control) or any other appropriate source. Once the language model has the description of the network vulnerability and information associated with the network configuration, the language model may analyze the vulnerability in light of the particular network configuration and determine what network devices are affected by the network vulnerability, and determine a course of defensive actions to mitigate the effect of this network vulnerability. The defensive actions to mitigate the effect of the network vulnerability may be configuration changes to the network that include one or more of network hardening (e.g., firewall rules, intrusion prevention, web application firewall (WAF) rule addition, etc.), service hardening (e.g., SSL authentication, least privileged enforcement, encryption, etc.), and detection (e.g., creating SIEM rules, building anomaly detection methods, crafting traffic signatures/patterns, etc.). Once the language model has determined configuration changes to mitigate the network vulnerability, this information may be input into a second language model that can break the high-level configuration changes down into specific subtasks in natural language. These subtasks may then be input into a configuration generation model. The configuration generation model may also be a language model or any other appropriate type of generative AI model. The configuration generation model may determine one or more possible specific small executable actions that will accomplish the subtask on particular network devices. Because there may be more than one actions that can be executed to implement a subtask, each subtask determined by the second language model may be input into the configuration generation model more than once. The configuration generator model may be trained to determine a series of steps required on a particular device or device management console in response to a desired configuration change. Once the configuration generation model has determined one or more possible executable action for each subtask, the one or more possible executable actions may be input into a configuration evaluation model to evaluate each possible action to determine an optimal action and prune away the less desirable options for the particular network. The configuration evaluation model may also be language model or other generative AI model trained on data sets such as given configuration A, configuration B, and condition C, determine whether configuration A or configuration B is preferable. It should be understood that one or many generative AI models may be used to implement the techniques described here. The examples described herein that include a first language model, a second language model, a configuration generation model, and a configuration evaluation model may be accomplished with any number of language models or other generative AI models. Note, although the techniques described herein are the context of mitigating a CVE, any other type of network vulnerability that is of concern may be mitigated using the techniques described herein.

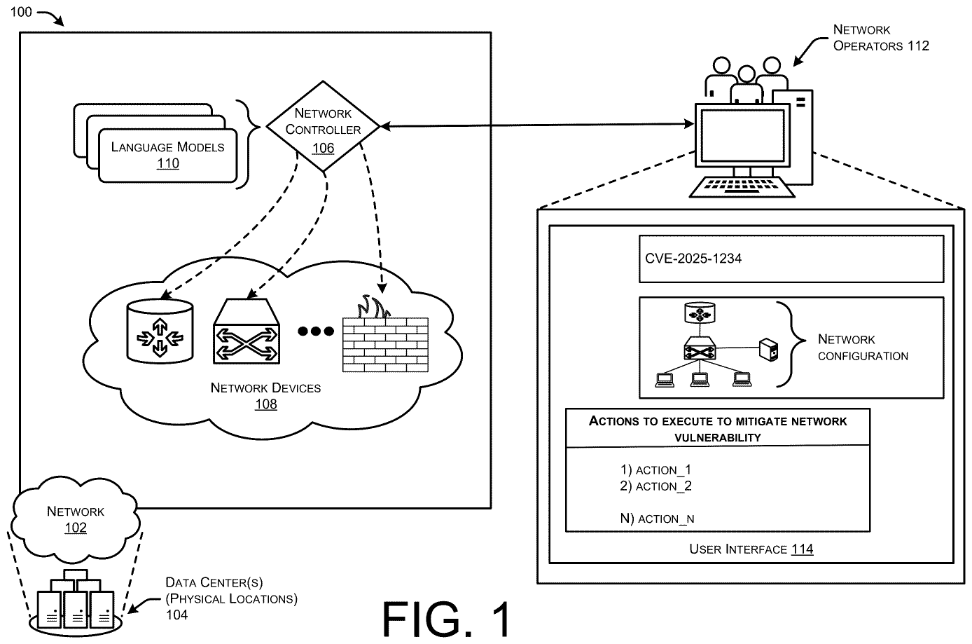

FIG. 1 illustrates a system-architecture diagram of an environment 100 in which language models deployed to a network controller determine actions to execute to mitigate network vulnerabilities.

The environment 100 may include a network 102 implemented by any viable communication technology, such as wired and/or wireless modalities and/or technologies. The network 102 may be any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)-both centralized and/or distributed-and/or any combination, permutation, and/or aggregation thereof. The network 102 may include devices, virtual resources, or other nodes that relay packets from one network segment to another by nodes in the computer network. The network 102 may include multiple devices that utilize the network layer (and/or session layer, transport layer, etc.) in the OSI model for packet forwarding, and/or other layers. The network 102 may include various network devices 108, such as routers, switches, gateways, firewalls, smart NICs, NICs, ASICs, FPGAs, servers, and/or any other type of device. Further, the network 102 may include virtual resources, such as VMs, containers, and/or other virtual resources. However, the network 102 may be of a different type of architecture, such as a WAN, IoT network, cellular network, or any other type of network.

The one or more data centers 104 may be physical facilities or buildings located across geographic areas that are designated to store networked devices that are part of the network 102. The data centers 104 may include various networking devices, such as network devices 108, as well as redundant or backup components and infrastructure for power supply, data communications connections, environmental controls, and various security devices. In some examples, the data centers 104 may include one or more virtual data centers which are a pool or collection of cloud infrastructure resources specifically designed for enterprise needs, and/or for cloud-based service provider needs. Generally, the data centers 104 (physical and/or virtual) may provide basic resources such as processor (CPU), memory (RAM), storage (disk), and networking (bandwidth). However, in some examples the devices may not be located in explicitly defined data centers 104, but may be located in other locations or buildings.

Environment 100 also includes a network controller 106. The network controller 106 may perform various techniques for managing the network 102 and the network devices 108 therein. For instance, the network controller 106 may manage network behavior and policies, network configuration and provisioning, traffic engineering and optimization, policy enforcement, visibility and monitoring, and other network management operations. In some examples, network operators 112 work with the network controller 106 to ensure that their network 102 is exhibiting desired characteristics, such as enforcing desired policies, implementing desired device configurations, or managing access to devices. Although described here as a network controller, other types of controllers may also be used to implement techniques described herein, such as system controllers and the like.

Environment 100 also include one or more language models 110. The language models may be large language mode (LLMs) or any other appropriate type of language model. Alternately or in addition, in some instances, although not illustrated, environment 100 may include other appropriate generative AI models in addition to, or in lieu of, the language models 110. A network operator(s) 112 may connect with the network controller 106 via one or more user interfaces 114 and once authenticated, the network operator 112 can interact with the language models 110 via the user interface 114 to issue inputs and commands for mitigating network vulnerabilities. The interfaces 114 may be web-based portals, application interfaces, websites, CLIs, APIs, and/or any other interface through which data may be communicated. According to the techniques described herein, the user interface(s) 114 may receive inputs or other data from the network operators 112 via text interfaces or other interactable elements as shown, thus, providing automated configuration changes customizable based on the policies and procedures of an enterprise organization.

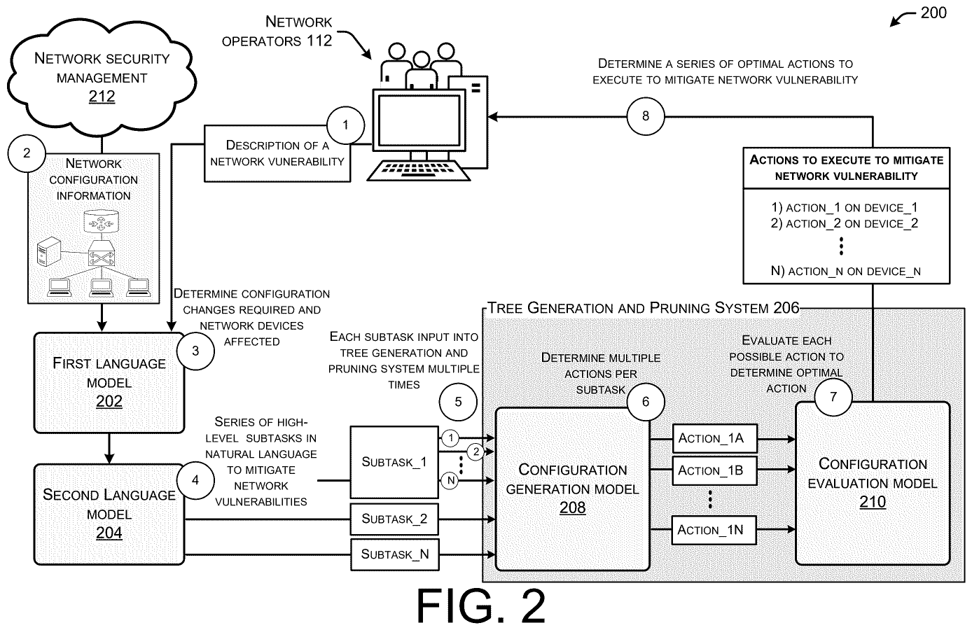

Environment 100 illustrates an example user interface 114 in which, a network operator 112 may login, and once the network operator 112 is authenticated, the example user interface 114 provides a text box for the network operator 112 to type in a description of a network vulnerability, provide a CVE number, or otherwise input information regarding a known network vulnerability. For example, the network operator 112 may input CVE number “CVE-2025-1234” as shown. In some examples, the user interface 114 may also include a text box in which a network operator may input information associated with the network configuration. Alternately, the information associate with the network configuration may be received from another source as described below with reference to FIG. 2. The user interface 114 may also include provisioning for the network operator 112 to receive a response from the system that indicates actions to execute to mitigate the network vulnerability that the network operator 112 input. As illustrated in example environment 100, the network operator 112 receives a series of executable actions 1-N to mitigate CVE-2025-1234. It should be understood that the interface 114 is an example and not meant to be limiting. It may display any number of interactable elements such as selectable buttons, text boxes, pull down menus, and the like.

There have been advances in artificial intelligence (AI) that have enabled chatbots and other AI systems to perform complex tasks that normally require human intelligence, such as perceiving, synthesizing, and inferring information. Generally speaking, AI systems and models ingest large amounts of data (or “training data”), analyze this data to identify correlations and patterns, and use these patterns to make predictions about future states. Although AI programs and algorithms have been around for decades, the amount of data and computing power needed to train AI models that are useful for humans has not existed. However, there have been various technological breakthroughs and advances that have accelerated the usefulness of AI, such as advent of cloud computing that provides effectively unlimited compute, advances in specialized hardware (e.g., graphics processing units (GPUs)) that efficiently train and run these AI models, and the discovery of more efficient training algorithms.

Generative AI is a type of artificial intelligence where models are used to create (or “generate”) new content based on inputs, often in the form of inputs from users. One type of generative AI model is particularly effective at generating text, specifically, the large language model (LLM). Language models 110 are trained on large sets or corpuses of text data to perceive and infer context from user queries, understand a broader range of queries, and generate human-like textual responses to the queries and determine appropriate function to call to acquire needed information. Chatbots that are backed by language models 110 are becoming increasingly popular among users due to their ability to perform complex tasks on behalf of users.

One type of neural network architecture that has gained popularity due to its ability to reduce the amount of time needed to train generative AI models is known as the Transformer model, or simply “Transformers.” Transformers apply a set of mathematical techniques, called attention or self-attention, to capture relationships in sequential data called tokens, such as words in a sentence. Transformers are able to detect subtle causal relationships between data elements in a series, including how even distant data elements influence and depend on each other. Unlike previous models that have to process tokens sequentially (e.g., Recurrent Neural Networks (RNNs)), transformers use an attention mechanism to process tokens simultaneously and calculate the attention weights, or strengths of relationships, between the tokens in successive layers. Because transformers can compute attention weights for all the tokens in parallel, the amount of time needed to train generative AI models using transformers is greatly improved over other training models.

Generative AI can be used to generate text that resembles human-like, or natural language, responses to inputs. Transformers are very effective in training the models used to generate text, often referred to as language models 110. Language models 110 are trained on large sets or corpuses of text data to generate human-like, natural language, textual responses to inputs. Language models 110 are generally trained in two stages, pre-training and fine-tuning. During the pre-training stage, language models 110 are trained on massive datasets of unlabeled text data (or “unsupervised learning”) where transformers allow the language models 110 to process and learn the patterns and relationships between words. During the fine-tuning stage, the language models 110 can be fine-tuned for specific tasks or inputs, such as summarizing content, answering questions, and text completion. There are generalized language models 110 that have been trained on sets of text data describing all types of content (e.g., data obtained from crawlers that scrape the public Internet). There are also specialized language models 110 that have been trained on specialized sets of data that are specific to a particular type of content, such as networking technology.

The language models 110 may simply be off-the-shelf language models that are deployed to the network controller 106, but in other examples, the language models 110 may be pre-trained on networking documentation and verbiage. In some instances, the language models 110 may be fine-tuned to determine which network devices are affected given a known vulnerability and what high level configuration changes are needed to mitigate the vulnerability. In some examples, the language models 110 may be fine-tuned to with datasets that include one or more actions to execute for a description of a network configuration change. In still other examples, language models 110 may be trained to evaluate possible all possible executable actions and determine an optimal series of executable action to take to implement a required configuration change to mitigate a network vulnerability.

FIG. 2 illustrates an example environment 200 for utilizing multiple language models or other generative AI models to output a series of optimal actions to execute to mitigate a network vulnerability to a network operator.

In environment 200, at (1) a network operator 112 may log into a network device that enables the network operator 112 to interact with one or more language models via a user interface to issue inputs and commands. For example, the network operator 112 may input a description of a known network vulnerability, a CVE number received from a CVE database, a description of a CVE, or the like. For example, with reference to FIG. 1, the network operator 112 types in a description of a CVE number into the user interface 114 as illustrated. At (2) network configuration information is input into a first language model 202. The network configuration information may include hardware and software configurations, device topology, applications, information regarding amounts of data traffic in the network and timing of more or less data traffic, and any other relevant information related to the functioning of a network and network devices. The network configuration information may be input from a network security management 212 as illustrated in FIG. 2, or any other appropriate sources.

At (3) the first language model 202 determines configuration changes required and network devices affected based on the description of the network vulnerability and the particular network architecture as received at (1) and (2). For example, the first language model 202 may be pretrained on network documentation and verbiage and fine-tuned to determine configuration changes necessary and devices affected given a vulnerability and a particular network configuration. First language model 202 may be one of the language model(s) 110 as illustrated and described with reference to FIG. 1.

A second language model 204 receives the configuration changes as determined by the first language model 202, and the network devices affected by the network vulnerability. At (4) the second language model 204 breaks the configuration changes required down into high-level subtasks, in natural language, and inputs each subtask into a tree generation and pruning system 206 at (5). Each subtask may be input to the tree generation and pruning system 206 one or more times. As shown at (5) subtask_1 is input into the tree generation and pruning system 206 N times. Although not shown subtask_2 and subtask_3 may also be input into the tree generation and pruning system 206 N times.

The tree generation and pruning system 206 includes a configuration generation model 208 and a configuration evaluation model 210. The tree generation and pruning system 206 finds the most promising paths for network vulnerability mitigation and prunes away candidate configurations that are less optimal based on a particular network configuration. The tree generation and pruning system 206 may output one or more of the most optimal series of executable actions that will mitigate the network vulnerability. At (6) the configuration generation model 208 outputs multiple actions per each subtask that is input to the tree generation and pruning system 206 at (5). In other words, a subtask may be a relatively simple or incremental required configuration change and the configuration generation model 208 determines a command or step necessary to implement the incremental change. Thus, the configuration generation model 208 may be fine-tuned on datasets that include one or more actions that can be executed to implement an incremental network configuration change. There may be multiple possible actions that can accomplish each subtask. Thus, in some instances, each subtask may be input to the configuration generation model 208 multiple time. Illustrated in example environment 200, subtask_1 is input into the configuration generation model 208 N times. Although not illustrated in example environment 200, each subtask 1-N may be input into the second language model 204 N times. Configuration generation model 208 may be one of the language model(s) 110 as illustrated and described with reference to FIG. 1. Configuration generation model 208 may be fine-tuned on datasets where given a small incremental configuration change, what are all the possible series of steps required on a particular device to implement the incremental change. It should be noted that actions 1A-1N may not all be different action, some or all of the actions may be the same or similar. Although not illustrated, the same process may be used for each subtask.

Each possible executable action (or series of actions) that can accomplish a subtask that are output by the configuration generation model 208, is then input into the configuration evaluation model 210. At (7) the configuration evaluation model 210 evaluates each possible executable action(s) for a subtask and determines which action is optimal based on the particular network configuration. As illustrated in environment 200, action_1A through action_1N that will accomplish subtask_1 are input into the configuration evaluation model 210 for evaluation. The configuration evaluation model will determine which of these actions is optimal to accomplish subtask_1 for the particular network configuration and the known network vulnerability. The configuration evaluation model 210 may be fine-tuned on datasets where given a first configuration, a second configuration, and a particular condition, a determination of whether the first configuration or the second configuration is optimal.

At (8) the configuration evaluation model 210 outputs a series of optimal actions to execute to mitigate the network vulnerability to the network operator 112. Alternately, the configuration evaluation model 210 outputs the optimal actions to execute to implement the mitigate the network vulnerability to the first language model 202. In this example, the first language model 202 then outputs the series of optimal actions to execute to mitigate the network vulnerability to the network operator 112 via the interface, for example interface 114 as described with reference to FIG. 1. Alternately or in addition, in some implementations, the actions may automatically be executed, or the network operator 112 may be inputed for approval of one or more actions prior to the actions being executed.

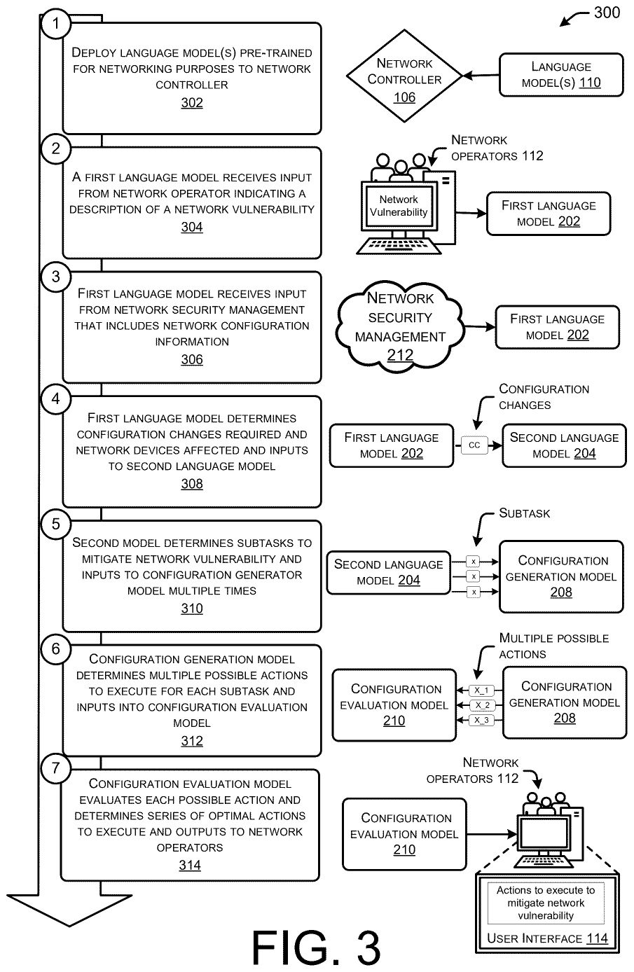

FIG. 3 illustrates a flow diagram 300 of an example method for using language models to recommend mitigate network vulnerabilities given a particular network configuration.

At 302, one or more language models 110 may be deployed to a network controller 106. In some examples the language models 110 may be pretrained on network specific documentation and verbiage, and fine-tuned for specific network functionality. The language models 110 may be pretrained for networks in general or for an enterprise organization's network in particular. With reference to FIG. 1, the language models may be a language models 110 deployed to the network controller 106. In some examples the network controller 106 may communicate with remote computing resources that generate language models to train the language models 110. The remote computing resources may be a cloud computing platform, an on-premises computing resource, or other available computing resources. In other instances, however, the network controller 106 itself may generate the language models 110. With reference to FIG. 2, the language models 110 may be any or all of the first language model 202, the second language model 204, the configuration generation model 208 and/or the configuration evaluation model 210.

At 304, a first language model 202 (e.g., one of the language models 110 deployed at 302) receives an input from a network operator 112 indicating a description of a known network vulnerability. For example, with reference to FIG. 1 a network operator 112 may input a CVE number into a user interface 114 as illustrated. Alternately or in addition, the network operator 112 may type in a description of a CVE or other known network vulnerability.

At 306, the first language model 202 receives an input from a network security management 212 that includes network configuration information. Alternately or in addition, the first language model 202 may receive information associated with the network configuration (e.g., devices in the network, locations of devices, software and hardware, information, etc.) from any appropriate source.

At 308, the first language model 202 determines configuration changes required and network devices affected and inputs them into a second language model 204. For example, with reference to FIG. 2 at (3) the first language model 202 determines configuration changes required and network devices affected and outputs this information into second language model 204. With reference to FIG. 1, a language model 110 determines configuration changes required on specific network devices 108 in the network 102. The configuration changes required may be one or more of network hardening (e.g., firewall rules, intrusion prevention, web application firewall (WAF) rule addition, etc.), service hardening (e.g., SSL authentication, least privileged enforcement, encryption, etc.), and detection (e.g., creating SIEM rules, building anomaly detection methods, crafting traffic signatures/patterns, etc.).

At 310, The second language model 204 determines high-level subtasks, in natural language, to accomplish the configuration changes required on the network devices for mitigating the network vulnerability as determined above. The second language model 204 then outputs the subtasks into a configuration generation model 208 one or more times. As illustrated in step 310, the subtask ‘x’ is input into the configuration generation model 208 three times. This example is not meant to be limiting and each subtask may be input into the configuration generation model more or less times. In addition, although only one subtask is illustrated as being input into the configuration generation model 208, it should be understood to those skilled in the art that each subtask determined in step 308 may be input one or more times. For example, with reference to FIG. 2 the second language model 204 breaks the configuration changes required down into high-level subtasks, in natural language, and inputs each subtask into the configuration generation model 208 at (5). Each subtask may be input to the configuration generation model 208 one or more times. As shown at (5) subtask_1 is input into the tree generation and pruning system 206 N times. Although not shown subtask_2 and subtask_3 may also be input into the tree generation and pruning system 206 N times.

At 312, each possible executable action (or series of actions) determined by the configuration generation model 208 may be input into the configuration evaluation model 210 multiple times as illustrated. configuration evaluation model 210 evaluates each possible executable action(s) for a subtask and determines which action is optimal based on the particular network configuration. For example, actions x_1 through x_3 that will accomplish subtask x are input into the configuration evaluation model 210 for evaluation. With reference to FIG. 2 action_1A through action_1N that will accomplish subtask_1 are input into the configuration evaluation model 210 for evaluation. The configuration evaluation model will determine which of these actions is optimal to accomplish subtask_1 for the particular network configuration and the known network vulnerability.

At 314, the configuration evaluation model 210 outputs the optimal series of actions to execute to mitigate the network vulnerability to the network operator 112 via the interface 114. Alternately or in addition, the optimal series of actions may be initiated automatically. Furthermore, in some instances, the configuration evaluation model 210 may input the network operator 112 for approval prior to initiating an action or the series of actions that will enable the configuration change.

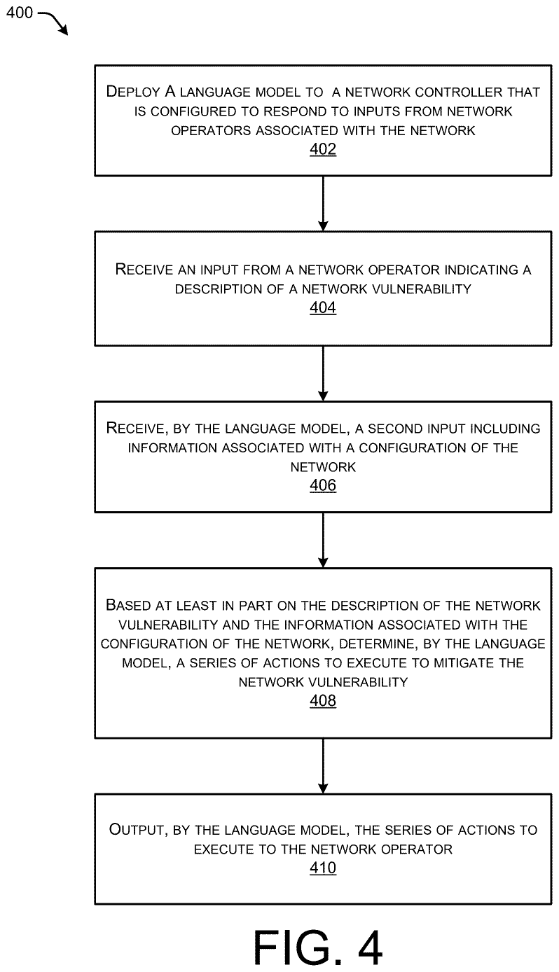

FIG. 4 illustrates a flow diagrams of an example method 400 that illustrates aspect of the functions performed at least partly by the devices described in FIGS. 1-3, such as the language models 110, first language model 202, and second language model 204. The logical operations described herein with respect to FIG. 4 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIG. 4 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

In some instances, the steps of methods 400 may be performed by a device and/or a system of devices that includes one or more processors and one or more non-transitory computer-readable media storing computer-executable instructions that, when executed by the one or more processors, cause the one or more processors to perform operations of method 400.

At operation 402, a language model is deployed to a network controller. The language model is configured to respond to inputs from network operators associated with a network. For example, with reference to FIG. 1, the language models 110 are deployed to the network controller 106. With reference to FIG. 3, at 302 a language models 110 are deployed to the network controller 106.

At operation 404, the language model receives an input from a network operator indicating a description of a network vulnerability. For example, with reference to FIG. 1 the interface 114 illustrates the text input from the network operator 112 in the text box “CVE-2025-1234.” As an example, if a network operator has a CVE number received from a CVE database, the network operator my input the CVE number in the interface 114. In other instances, the network operator may type in a description of the CVE or other network vulnerability.

At operation 406, the language model receives a second input that includes information associated with a configuration of the network. For example, with reference to FIG. 2, at (2) the first language model 202 receives network configuration information from a network security management 212. With reference to FIG. 3, at 306 the first language mode 202 receives network configuration information from a network security management 212.

At operation 408, based at least in part on the description of the network vulnerability and the information associated with the configuration of the network, the language model determines a series of actions to execute to mitigate the network vulnerability. For example, with reference to FIG. 1, language model(s) 110 deployed to network controller 106 may determine a series of actions to execute to implement the required configuration change. As illustrated in user interface 114, actions 1-N have been determined as the series of actions to execute to mitigate the network vulnerability. With reference to FIG. 2, the first language model 202 receives the description of the network vulnerability by the network operator 112 at (1), and the information associated with the network configuration at (2) and determines configuration changes required and network devices affected at (3) and input the configuration changes and network devices affected into the second language model 204. At (4) the second language model breaks the high level configuration change requirement description down into smaller incremental subtasks at and outputs a description of each subtask to a configuration generation model 208. Each subtask may be input to the configuration generation model 208 multiple times at (5), and the configuration generation model determines multiple possible actions to execute per for each subtask at (6). The configuration generation model 208 inputs each possible executable action for each subtask into the configuration evaluation model 210. The configuration evaluation model 210 evaluates each possible action to determine an optimal action at (7).

At operation 410, the language model outputs the series of actions to execute to the network operator. For example, with reference to FIG. 1 the series of actions 1-N are presented to the network operator 112 via the interface 114. In another example, with reference to FIG. 2 at (8) the series of optimal actions to mitigate the network vulnerability are output to the network operator 112. In some examples, the language models may automatically implement the series of optimal actions, or input the network operator 112 for approval before automatically executing one or more actions. Whether to automatically implement actions may be customizable and tailored to a specific organizations need, or dependent on the severity or extent of a recommended change.

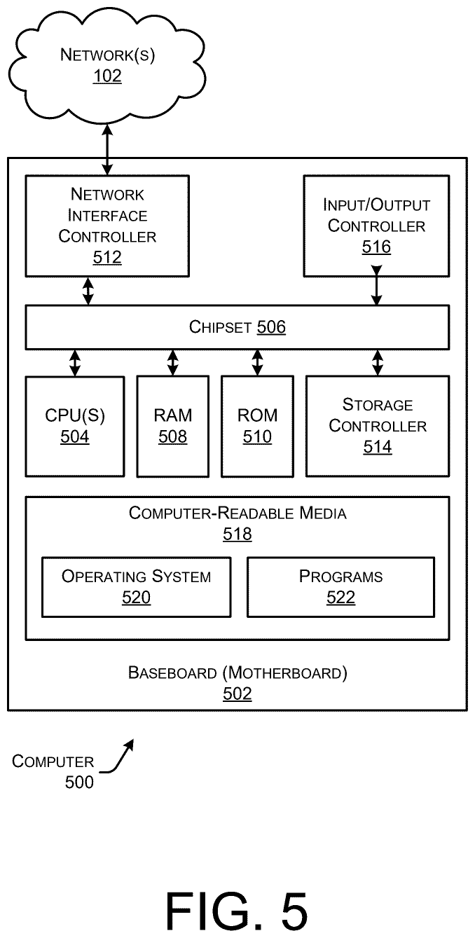

FIG. 5 shows an example computer architecture for a device capable of executing program components for implementing the functionality described above. The computer architecture shown in FIG. 5 illustrates any type of computer 500, such as a conventional server computer, workstation, desktop computer, laptop, tablet, network appliance, e-reader, smartphone, or other computing device, and can be utilized to execute any of the software components presented herein.

As described herein, the computer 500 may be any type of device, such as network controller 106 or network devices 108. Thus, the computer 500 may, in some examples, correspond to any device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 500 includes a baseboard 502, or “motherboard,” which is a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the computer 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computer 500. The chipset 506 can further provide an interface to a computer-readable storage medium such as a read-only memory (“ROM”) 510 or non-volatile RAM (“NVRAM”) for storing basic routines that help to startup the computer 500 and to transfer information between the various components and devices. The ROM 510 or NVRAM can also store other software components necessary for the operation of the computer 500 in accordance with the configurations described herein.

The computer 500 can operate in a networked environment using logical connections to remote computing devices and computer systems through a network, such as the network 102. The chipset 506 can include functionality for providing network connectivity through a NIC 512, such as a gigabit Ethernet adapter. The NIC 512 is capable of connecting the computer 500 to other computing devices over the network 102. It should be appreciated that multiple NICs 512 can be present in the computer 500, connecting the computer to other types of networks and remote computer systems.

The computer 500 can be connected to a storage device 518 that provides non-volatile storage for the computer. The storage device 518 can store an operating system 520, programs 522, and data, which have been described in greater detail herein. The storage device 518 can be connected to the computer 500 through a storage controller 514 connected to the chipset 506. The storage device 518 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 500 can store data on the storage device 518 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 518 is characterized as primary or secondary storage, and the like.

For example, the computer 500 can store information to the storage device 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 500 can further read information from the storage device 518 by detecting the physical states or characteristics of one or more particular locations within the physical storage units.

In addition to the mass storage device 518 described above, the computer 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 500. In some examples, the operations performed by the network controller 106, the network devices 108, the device(s) operated by the network operators 112 with user interface 114, and or any components included therein, may be supported by one or more devices similar to computer 500. Stated otherwise, some or all of the operations performed by network controller 106, the network devices 108, and/or device(s) operated by the network operators 112 having user interface 114, and or any components included therein, may be performed by one or more computer devices 500.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 518 can store an operating system 520 utilized to control the operation of the computer 500. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 518 can store other system or application programs and data utilized by the computer 500.

In one embodiment, the storage device 518 or other computer-readable storage media is encoded with computer-executable instructions which, when loaded into the computer 500, transform the computer from a general-purpose computing system into a special-purpose computer capable of implementing the embodiments described herein. These computer-executable instructions transform the computer 500 by specifying how the CPUs 504 transition between states, as described above. According to one embodiment, the computer 500 has access to computer-readable storage media storing computer-executable instructions which, when executed by the computer 500, perform the various processes described above with regard to FIGS. 1-4. The computer 500 can also include computer-readable storage media having instructions stored thereupon for performing any of the other computer-implemented operations described herein.

The computer 500 can also include one or more input/output controllers 516 for receiving and processing input from a number of input devices, such as a keyboard, a mouse, a touchpad, a touch screen, an electronic stylus, or other type of input device. Similarly, an input/output controller 516 can provide output to a display, such as a computer monitor, a flat-panel display, a digital projector, a printer, or other type of output device. It will be appreciated that the computer 500 might not include all of the components shown in the Figures, can include other components that are not explicitly shown in FIG. 5, or might utilize an architecture completely different than that shown in FIG. 5.

As described herein, the computer 500 may comprise one or more of the network controller 106, network devices 108 and/or any other device. The computer 500 may include one or more hardware processors 504 (processors) configured to execute one or more stored instructions. The processor(s) 504 may comprise one or more cores. Further, the computer 500 may include one or more network interfaces configured to provide communications between the computer 500 and other devices, such as the communications described herein as being performed by the network controller 106, the network devices 108 and/or the devices operated by the network operators 112 with user interface 114. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 522 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for utilizing a language model to mitigate a network vulnerability, the method comprising:
deploying the language model that is configured to respond to inputs from network operators associated with a network;
receiving, by the language model, a first input from a network operator indicating a description of the network vulnerability;
receiving, by the language model, a second input including information associated with a configuration of the network;
based at least in part on the description of the network vulnerability and the information associated with the configuration of the network, determining, by the language model, a series of actions to execute to mitigate the network vulnerability; and
outputting, by the language model, the series of actions to execute to the network operator.

2. The method of claim 1, wherein determining the series of actions to execute further comprises:
determining network devices that are affected by the network vulnerability; and
determining one or more actions to execute on each of the network devices to mitigate the network vulnerability.

3. The method of claim 1, wherein the language model is a first language model and wherein determining the series of executable actions further comprises:
determining a high-level configuration change to the configuration of the network that will mitigate the network vulnerability;
determining a natural language description of a series of subtasks for implementing the high-level configuration change;
inputting the natural language description of each subtask into a second language model; and
receiving from the second language model an action to execute for each subtask, wherein each action to execute includes a network device on which to execute the action.

4. The method of claim 3, wherein the natural language description of a subtask is input into the second language model multiple times and further comprising:
generating, by the second language model, multiple possible actions to execute to implement the subtask;
inputting a description of each of the multiple possible actions to execute into a decision tree model; and
receiving from the decision tree model an optimal action to execute for the subtask.

5. The method of claim 1, wherein the series of actions to execute include a series of Command Line Interface (CLI) commands for input to one or more network devices.

6. The method of claim 1, wherein the network vulnerability is Common Vulnerabilities and Exposures (CVE) report received from a CVE database.

7. The method of claim 1, wherein the language model is a large language model (LLM).

8. A system comprising:
one or more processors; and
one or more computer-readable media storing computer-executable instructions that, when executed by the one or more processors, cause the one or more processors to perform operations comprising:
deploying a language model that is configured to respond to inputs from network operators associated with a network;
receiving, by the language model, a first input from a network operator indicating a description of a network vulnerability;
receiving, by the language model, a second input including information associated with a configuration of the network;
based at least in part on the description of the network vulnerability and the information associated with the configuration of the network, determining, by the language model, a series of actions to execute to mitigate the network vulnerability; and
outputting, by the language model, the series of actions to execute to the network operator.

9. The system of claim 8, wherein determining the series of actions to execute further comprises:
determining network devices that are affected by the network vulnerability; and
determining one or more actions to execute on each of the network devices to mitigate the network vulnerability.

10. The system of claim 8, wherein the language model is a first language model and wherein determining the series of executable actions further comprises:
determining a high-level configuration change to the configuration of the network that will mitigate the network vulnerability;
determining a natural language description of a series of subtasks for implementing the high-level configuration change;
inputting the natural language description of each subtask into a second language model; and
receiving from the second language model an action to execute for each subtask, wherein each action to execute includes a network device on which to execute the action.

11. The system of claim 10, wherein the natural language description of a subtask is input into the second language model multiple times and further comprising:
generating, by the second language model, multiple possible actions to execute to implement the subtask;
inputting a description of each of the multiple possible actions to execute into a decision tree model; and
receiving from the decision tree model an optimal action to execute for the subtask.

12. The system of claim 8, wherein the series of actions to execute include a series of Command Line Interface (CLI) commands for input to one or more network devices.

13. The system of claim 8, wherein the network vulnerability is Common Vulnerabilities and Exposures (CVE) report received from a CVE database.

14. The system of claim 8, wherein the language model is a large language model (LLM).

15. One or more non-transitory computer-readable media storing instructions that, when executed, cause one or more processors to perform operations comprising:
deploying a language model that is configured to respond to inputs from network operators associated with a network;
receiving, by the language model, a first input from a network operator indicating a description of a network vulnerability;
receiving, by the language model, a second input including information associated with a configuration of the network;
based at least in part on the description of the network vulnerability and the information associated with the configuration of the network, determining, by the language model, a series of actions to execute to mitigate the network vulnerability; and
outputting, by the language model, the series of actions to execute to the network operator.

16. The one or more non-transitory computer-readable media of claim 15, wherein determining the series of actions to execute further comprises:
determining network devices that are affected by the network vulnerability; and
determining one or more actions to execute on each of the network devices to mitigate the network vulnerability.

17. The one or more non-transitory computer-readable media of claim 15, wherein the language model is a first language model and wherein determining the series of executable actions further comprises:
determining a high-level configuration change to the configuration of the network that will mitigate the network vulnerability;
determining a natural language description of a series of subtasks for implementing the high-level configuration change;
inputting the natural language description of each subtask into a second language model; and
receiving from the second language model an action to execute for each subtask, wherein each action to execute includes a network device on which to execute the action.

18. The one or more non-transitory computer-readable media of claim 17, wherein the natural language description of a subtask is input into the second language model multiple times and further comprising:
generating, by the second language model, multiple possible actions to execute to implement the subtask;
inputting a description of each of the multiple possible actions to execute into a decision tree model; and
receiving from the decision tree model an optimal action to execute for the subtask.

19. The one or more non-transitory computer-readable media of claim 15, wherein the network vulnerability is Common Vulnerabilities and Exposures (CVE) report received from a CVE database.

20. The one or more non-transitory computer-readable media of claim 15, wherein the language model is a large language model (LLM).
